(19) United States
(12) Patent Application Publication
(10) Pub. No.: US 2001/0015722 A1
(43) Pub. Date: Aug. 23, 2001

(54) Lock key condition-indicator accessory for a computer

(76) Inventor: Andrew Blencowe, Windham, NH (US)

Correspondence Address: McLane, Graf, Raulerson & Middleton, Professional Association, P.O. Box 326, 900 Elm Street, Manchester, NH, 03105-0326, US

(21) Appl. No.: 09/749,841

(22) Filed: Dec. 27, 2000

Related U.S. Application Data
(63) Continuation of application No. 09/072,170, filed on May 4, 1998, now abandoned.

(51) Int. Cl. G09G 5/00

(52) U.S. Cl. 345/170; 345/168

(57) ABSTRACT

The present invention is directed to an accessory that can be used to remotely indicate the status of a lock key or lock keys located on the conventional computer keyboard. It is designed to be used with the conventional computer keyboard that has one or more lock keys and indicator lights located on the keyboard itself. The accessory comprises a keyboard cable connecting the computer and keyboard, intercepted by a junction, a remote visual indicator, having one end connected to the junction and one end having an LED indicator for positioning in a location remote from the keyboard, a hardware signature analyzer or some other means in the junction for detecting the condition of the lock key, and a power supply in the junction for powering the remote visual indicator to indicate the condition of the lock key.

This is a continuation of U.S. patent application Ser. No. 09/072,170, filed May 4, 1998, now abandoned as of the filing date of this continuation application.

### FIELD OF THE INVENTION

This invention relates to an accessory for indicating at a remote location from a computer keyboard the condition of a lock key or keys on the computer keyboard.

### BACKGROUND OF THE INVENTION

Computer keyboards typically have three lights that indicate the setting of the “lock” keys on the keyboard. Typically these lights are located on the keyboard adjacent to one another, and some keyboards have the indicator lights located on the respective keys themselves. On most keyboards, these indicator lights are grouped together in the upper right hand corner of the keyboard. Typical computer keyboards have one light to indicate the setting of the “NUM LOCK” key, one light to indicate the setting of the “CAPS LOCK” key, and one light to indicate the setting of the “SCROLL LOCK” key. If the “NUM LOCK” key state is set, then the light corresponding to the “NUM LOCK” key will be lit, etc. These lights typically consist of light emitting diodes (“LED's”) that draw their power from the actual computer and are controlled by the circuitry that is built into the keyboard. Computer keyboards may have chips within them that control these lights and send the actual key codes to the computer. Additionally, many word-processing or other software applications provide some type of visual indication on the display screen indicating the status of the lock keys.

The indicator lights located on the keyboard serve the necessary function of allowing the operator to look at the keyboard and determine the status of one or more of the keyboard lock keys. The indicator lights located on the keyboard also provide the user instant status feedback when the user is looking at the keyboard and toggling one of the lock keys on or off.

However, it has been the experience of typists and others who routinely work at computer keyboards that they have forgotten the setting of one of the lock keys and have continued to type, oblivious to the fact that the characters being entered are all caps, make no sense, or present other irregularities. To rectify this, often long passages have had to be retyped with the proper lock key setting.

The root of this problem is that the LED indicator lights located on the keyboard have not been visible to the operator who, if he is experienced, will not be looking at the keyboard as he types his entries. The LED has been outside of his peripheral vision, and the communication by the keyboard LED's of the condition of the lock key has not properly reached the operator.

Additionally, indicators produced on the display screen by software programs do not normally catch the attention of the experienced typist. The experienced typist is trained not to concentrate on the display of typed text while typing, but rather on the materials to be typed.

In an attempt to overcome this limitation of the indicator lights located on the keyboard itself, U.S. Pat. No. 5,856,785, issued to Bowie et al., discloses an apparatus and method for generating an audible signal to indicate the status of the capslock key. Although the Bowie invention presents one way of overcoming the limitations of the indicator lights located on the computer keyboard, it does not help those computer operators that are deaf or hard of hearing. It also presents an indicator system that may not be preferable to some users because if the audible indicator is arranged so that it emits a discrete “beep” or other discrete audible indicator, it does not serve as a continual reminder to the user that a lock key is or is not locked. If it is arranged so that it produces a continual audible indicator, it may distract or annoy the user.

Thus, there is a need for an apparatus that presents a visual indicator that can be located remotely from the computer in order to notify the user of the status of one or more of the lock keys on the computer. There especially is a need for a visual indicator that can be located adjacent to the text being typed by a keyboard operator or at another location according to an individual user's desires. This remotely located visual indicator would be used in conjunction with the indicator lights located on the keyboard, as those indicator lights serve their own separate purpose as described above.

### SUMMARY OF THE INVENTION

The present invention proposes an accessory which can be installed in place of the keyboard cable, the accessory providing an indicator which can be positioned remotely from the keyboard at a location which is within the operator's peripheral vision. The indicator can be located adjacent to the text, above or below the display screen, or at another preferred location within the keyboard operator's peripheral vision.

In other words, the invention is a condition indicator accessory for a computer having a display screen and a keyboard with at least one lock key and at least one indicator light corresponding to the condition of the lock key, the accessory remotely indicating the condition of the lock key on the computer keyboard. The accessory comprises a keyboard cable adapted to connect the keyboard to the computer, the cable being intercepted by a junction. A visual indicator is connected to the junction, the indicator having an indicating end for mounting in a location remote from the keyboard. The invention also includes activating means in the junction for detecting the condition of the lock key and for powering the indicator to indicate the condition of the lock key. In a preferred version, plural indicator lights have been used for the respective lock keys located on the keyboard.

It is an important aspect of the present invention to provide an apparatus for visually indicating the condition of one or more of the lock keys located on the typical computer keyboard, wherein the apparatus can be located remotely from the keyboard.

It is a further aspect of the invention to provide an apparatus that can be used to alert word processors and other typists to a change in the condition of a keyboard lock key without requiring the user to look away from the text that they are typing.

It is another aspect of the invention to provide an indicating apparatus located remotely from the keyboard that can be used by those who are deaf or hard of hearing.

### BRIEF DESCRIPTION OF THE DRAWINGS

Further objects and features of the invention will be clear to those skilled in the art from a review of the following specification and drawings, all of which present a non-limiting form of the invention. In the drawings:

FIG. 1 is a perspective view of an accessory embodying the invention installed on a computer;

FIG. 2 is an enlarged top plan view of the indicator ends as attached to the top of a monitor as in FIG. 1;

FIGS. 3 through 9 are circuit and other diagrams used in the practice of the invention.

### DETAILED DESCRIPTION OF THE INVENTION

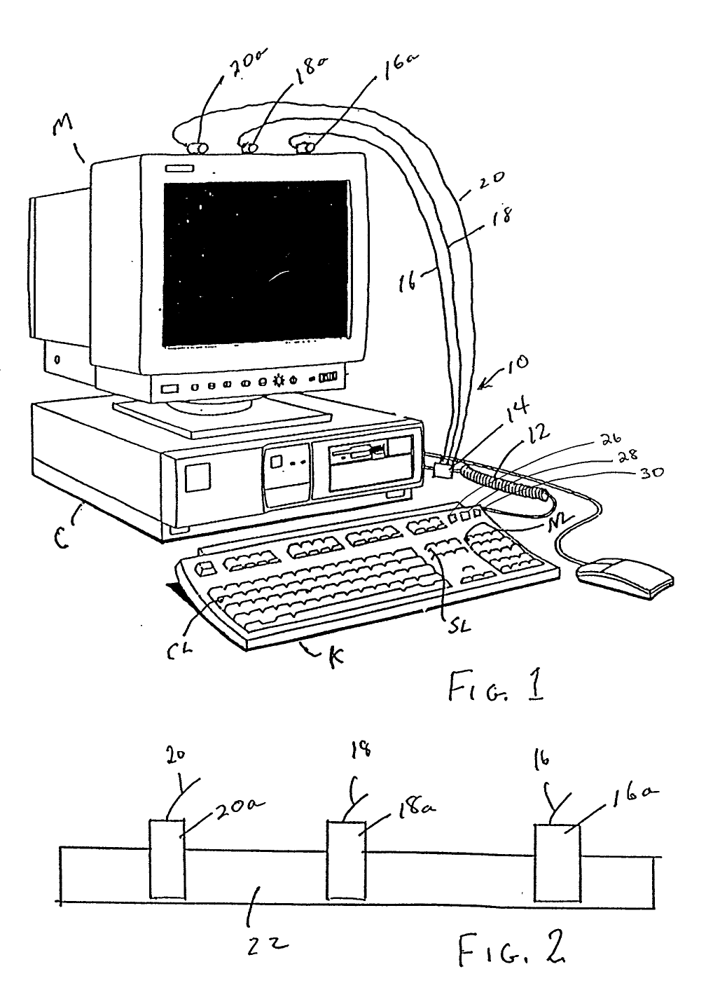

An accessory embodying the invention is generally designated 10 in FIG. 1 and is shown installed in a computer. The computer comprises the usual computer console C containing the hard drive, floppy disk receiver, etc., the monitor M having a display screen, and the keyboard K. The console and the monitor are connected by cables (not shown). The keyboard K and console C are connected by a cable assembly 12 which comprises in the version shown the accessory which is the subject of the invention. As with the usual keyboard cable, it is attached at its ends respectively by connectors shown to the keyboard and the console.

The cable 12 of the accessory is intercepted by a junction 14 which contains structure to be discussed and from which conductors shown as three separate wires 16, 18 and 20 extend to ends 16a, 18a, and 20a, which contain respective LED's visible to the operator.

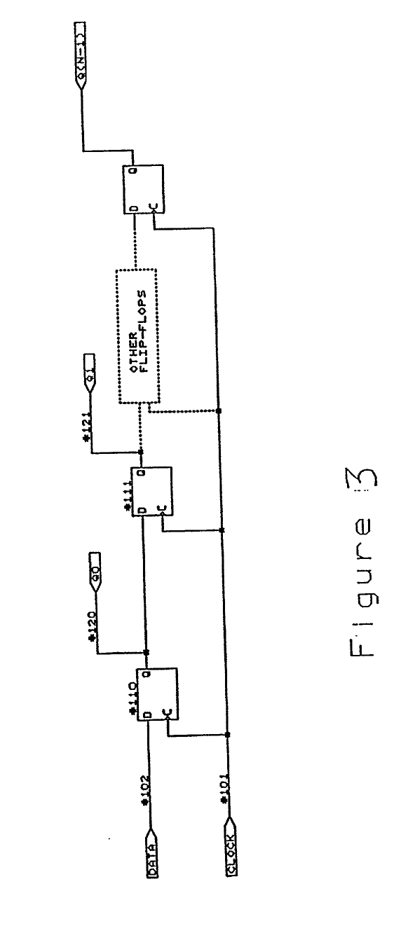

The LED's are generally in cylindrical housings (FIG. 2) and are girdled respectively by VELCRO fasteners of one sex which are engaged by a strip 22 of upwardly facing VELCRO fastener of the opposite sex. The strip is preferably provided on its lower face with an adhesive which may be covered by a peel strip before it is installed. In practice, the strip 22 can be adhered to a user's preferred line of peripheral vision at his or her normal workplace. As shown in FIG. 1, the strip 22 can be adhered to the front of the top flat surface of the monitor.

As is well known in the art, the keyboard K is provided with the usual keys which include the “CAPS LOCK” CL, “NUM LOCK” NL and “SCROLL LOCK” SL. The keyboard shown has three indicator lights, one indicator light 26 for indicating the condition of the CAPS LOCK key CL, one indicator light 28 for indicating the condition of the NUM LOCK key NL, and one indicator light 30 for indicating the condition of the SCROLL LOCK key SL. Other keyboards, not shown, may have the indicator lights positioned on the top surface of the respective lock keys themselves.

It should be understood that the junction 14 may actually be incorporated into one of the connectors of the keyboard cable 12. For instance, the connector (not shown) which connects the cable to the rear of the computer console C may be enlarged to house the junction 14 and it would be from that location that the three indicator wires 16, 18, 20 extend up to the ends 16a, 18a, 20a respectively.

When one or more of the lock keys CL, NL, and SL are depressed, the respective lock key indicator lights 26, 28, and 30 located on the keyboard K will light. With the accessory installed simultaneously with depressing one of the key locks, the CL, NL, SL, the respective indicator ends 16a, 18a and 20a will also light. The latter lights, however, will be much more readily visible to the operator who does not have his eyes on the keyboard. As a result, it will be unlikely that the operator will proceed with typing with a lock key set beyond the intended duration.

### Modes of Effecting the Invention

The following describes the preferred embodiment of the present invention. Numerous specific details are described, however, the invention can be practiced without these details. For example, the preferred embodiment is described as a hardware signature analyzer, a device that examines the signals for a certain distinct pattern, but the same technique could be implemented in software by a micro-controller rather than in hardware logic as is shown. Also, keyboard LED detection can be performed by other techniques, such as inserting a micro-controller between the keyboard and PC (IBM-AT and clones), thus intercepting all messages. The preferred embodiment shown here attaches in parallel with the signals going between the PC and keyboard, and merely listens in on the conversation. This results in a simpler, and, hence, lower-cost solution.

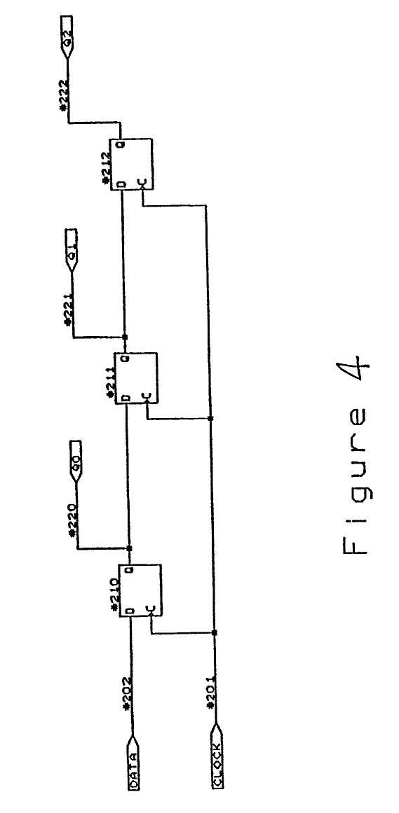

FIG. 3 shows an N-bit shift register. The shift register is made up of N individual flip-flops, such as #110, concatenated together. When clock line #101 transitions from a digital low state to a digital high state, data line #102 is sampled (captured) and held by the output flip-flop #110. Following the LTHCT (low-to-high clock transition), the captured data appears on flip-flop output QO #120. Since all the flip-flops share a common clock #101, the LTHCT causes flip-flop #111 to capture the state of the output of flip-flop #110. As this occurs before flip-flop #110 is changed to its new value, the output of flip-flop #111, Q1 #121, after the LTHCT is a copy of the output of flip-flop #110, QO #120, before the LTHCT. Thus, the shift register has a “memory” effect, preserving old values of the sampled data. Table T-200 illustrates how a 3-bit shift register shown in FIG. 4 would capture data.

Assume that all outputs #220, #221, and #222 of their corresponding flip-flops #210, #211, and #212 are all at a digital low state at the start of the first LTHCT. The first row of table T-200 shows that the clock #201 is low, the data #202 is high, and all outputs are low. The second row shows that the clock #201 has gone from low to high, so we have a LTHCT. The outputs are shown in their steady state, which follows the LTHCT. Note that QO #220 has a copy of the data #202 that was present before the LTHCT. The third through fifth rows show changes on the clock #201 and data #202 lines, but the outputs QO through Q2, #220 through #222, are not affected. This is because no LTHCT has occurred. The sixth row shows the clock #201 going from low to high, and this LTHCT captures the new high date #202 in QO #220 while shifting the old data, i.e., Q1 #221 after the LTHCT becomes what was QO #220 before the LTHCT. Similarly, Q2 #222 after the LTHCT becomes what was Q1 #221 before the LTHCT. The seventh and eight rows illustrate another LTHCT, showing how date #202 is sampled (captured) and old values are shifted down the outputs QO through Q2, #220 through #222, Thus, following every LTHCT, the outputs QO 10 through Q2, #220 through #222, contain a time sampled history of the data #202. This history will be exploited to extract the LED's status lights on the keyboard.

TABLE T-200
3-bit shift register example

| Row | Clock | Data | Q0 #220 | Q1 #221 | Q2 #222 |
|---|---|---|---|---|---|
| 1 | L | H | L | L | L |
| 2 | H | H | H | L | L |
| 3 | H | L | H | L | L |
| 4 | L | L | H | L | L |
| 5 | L | H | H | L | L |
| 6 | H | H | H | H | L |
| 7 | L | L | H | H | L |
| 8 | H | L | L | H | H |

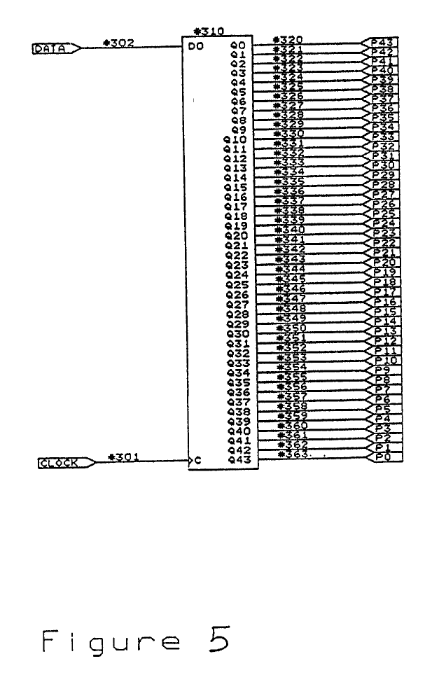

FIG. 5 shows a 44-bit shift register, shown as a single schematic symbol. Although 44-bit shift registers are used to demonstrate the preferred embodiment, it is possible to detect a subset of the required signature, and build an embodiment using fewer flip-flops. For example, as will become obvious later, the entire “second acknowledge” could be dropped to reduce the number of flip-flops, but retaining this term assures extra integrity. Thus, reducing the detected signature using fewer flip-flops is considered obvious.

FIG. 5 shows that a LTHCT on clock #301 samples (captures) data #302, and the resulting output and output history appears on QO through Q43, #320 through #363. These signals are assigned to names P43 through PO. Thus, after any LTHCT, assuming that at least 44 LTHCT have occurred, PO represents the oldest sampled data, while P43 represents the newest sampled data.

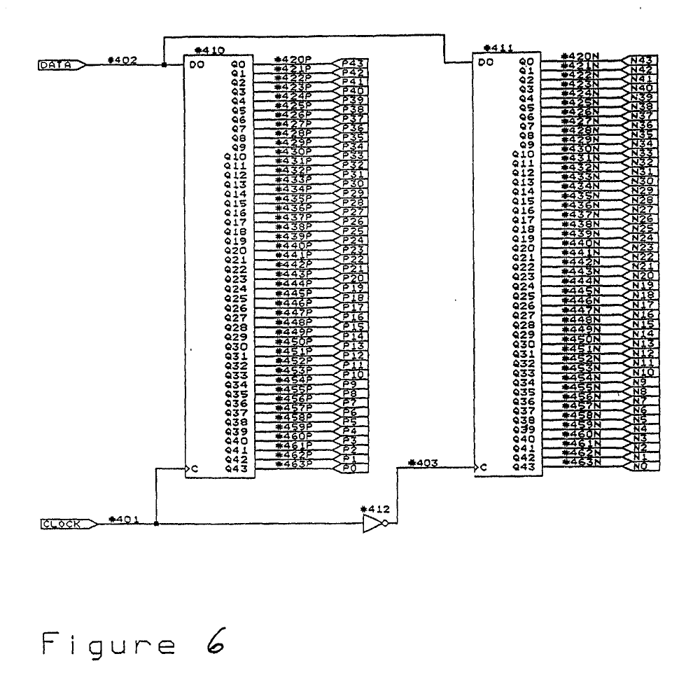

FIG. 6 shows two 44-bit shift registers, #410 and #411. The clock signal #403 to shift register #411 is inverted by inverter #412. This has the effect of sampling the data #402 on the HTLCT (high-to-low clock transition) rather than the LTHCT. Thus, flip-flop #410 samples data on the LTHCT while flip-flop #411 samples data on the HTLCT. As mentioned earlier, using a subset of the technique is possible, but the relatively few number of gates (considering the size of current gate array technology) in this design does not warrant trimming the logic to its minimum, and it is preferred to sample on both edges to obtain a reliable signature. Thus, after any LTHCT, assuming that at least 44 LTHCT have occurred and the initial state of clock #401 was high, (which is the idle state for the PC and keyboard), PO represents the oldest rising-edge LTHCT sampled data, while P43 represents the newest rising-edge LTHCT sampled data, and NO represents the oldest falling-edge HTLCT sampled data, while N43 represents the newest rising-edge HTLCT sampled data.

The PC (IBM-AT and clones) and keyboard communicate via two lines, clock and data. There is no published standard for this protocol, and this gives rise to keyboards and PCs that can work differently from the original IBM-AT. Although describing the operation of the keyboard and PC protocol can be cumbersome, a complete description is not required to understand this embodiment. Instead, what is required is to understand the sequence that controls the LED's (light emitting diodes). Although the keyboard controls the physical state (on or off) of the LED's, it does so only when instructed by the PC. This is why depressing the NUM LOCK key on the keyboard and observing if the NUM LOCK LED does not change can be used for an indication that the PC has probably hard-crashed. To change the LED's, the PC sends an “ED” command, to signify that the LED's are to be updated. This command may abort (suspend) a transmission from the keyboard that is already in progress, but nevertheless, the ED command will be the start of the LED update sequence. ED represents the hexadecimal value ED, which in binary is written 11101101. Transmissions to and from the keyboard are sent LSB (lease significant bit) first, and then ED would be sent 10110111. In addition, a start bit is sent before the data, an odd parity bit is sent after the data, and a stop bit follows the parity bit. The keyboard samples the data from the PC on the LTHCT of the clock line, while the PC samples the data from the keyboard on the HTLCT. The idle state for the communication link has the clock line high. After the ED command, the keyboard will send an FA acknowledge command. Next, the PC will send the new data which will update the NUM LOCK, CAPS LOCK, arid SCROLL LOCK LED's on the keyboard. Finally, the keyboard will send a second FA acknowledge.

After each LTHCT, after a short delay that allows the shift register outputs to settle, the outputs can be compared against a known pattern, to be described. If there is a pattern match, then the LED status can be extracted from the shift register outputs.

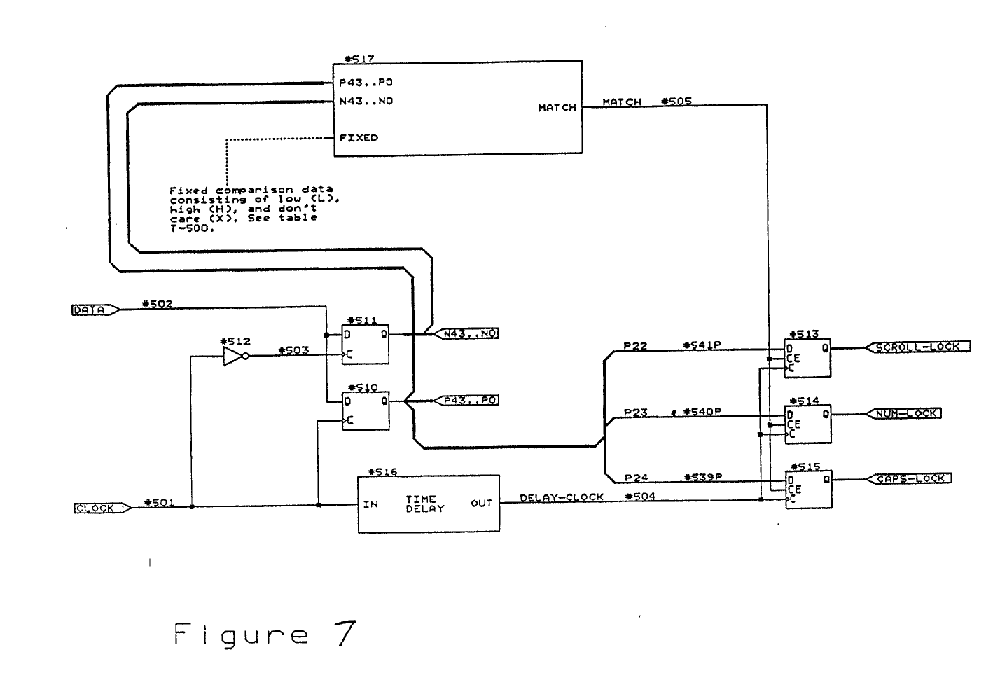

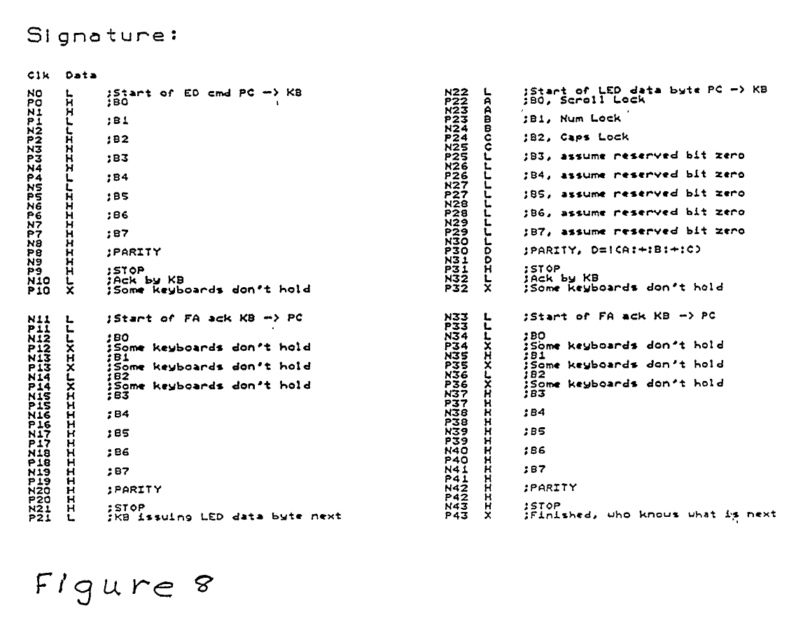

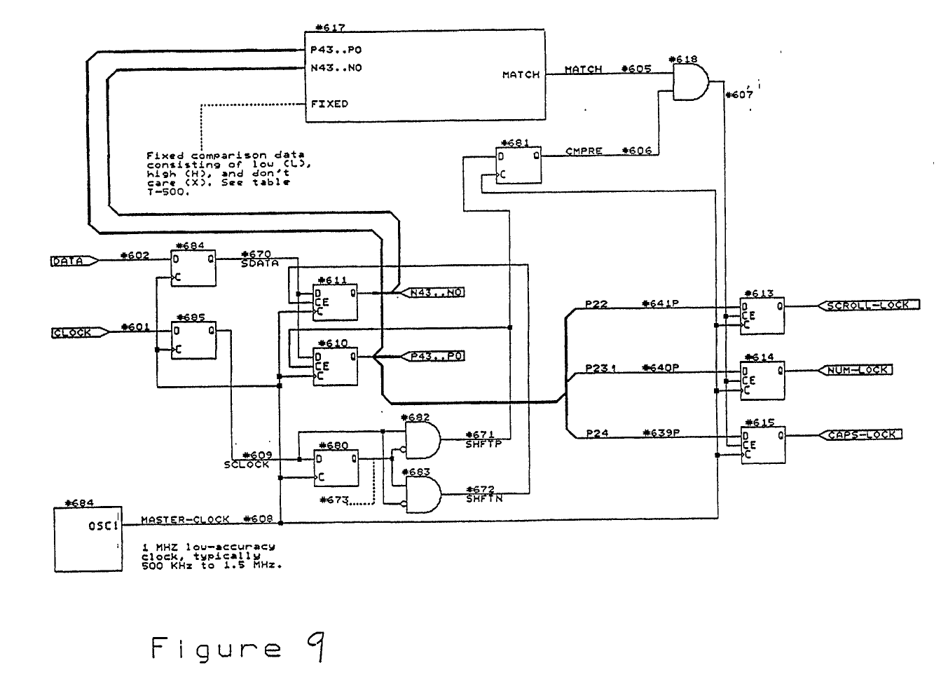

FIG. 7 and FIG. 8 show how the preferred embodiment captures the LED data being sent from the PC to the keyboard. #510 is the shift register that captures data on the LTHCT, analogous to #410 of FIG. 6. #511 is the shift register that captures data on the HTLCT, analogous to #411 of FIG. 6. #517 is combinatorial comparison logic. Match output #505 only goes high when P43 . . . PO and N43 . . . NO compare according to FIG. 8. #516 is a small time delay that allows shift registers #510 and #511 to settle their outputs, and allows sufficient delay for combinatorial comparison logic #517 to decode a match (the majority of the cumulative delay is spent decoding the match). The output of delay #516 is a delayed clock, delay-clock #504. Delay-clock #504 clocks flip-flops #513, #514, and #515. These flip-flops have a clock enable input. If the clock enable input is low, the LTHCT is ignored. Else, if the clock enable input is high, the LTHCT samples (captures) the data inputs as follows: #513 samples shift register #510's P22 output #541P, which represents the SCROLL LOCK LED status; #514 samples shift register #510's P23 output #540P, which represents the NUM LOCK LED status; #515 samples shift register #510's P24 output #539P, which represents the CAPS LOCK LED status.

The comparison logic #517 compares the outputs from the #510 and #511 shift register outputs, P43 . . . PO and N43-NO respectively against the fixed signature, as shown in FIG. 8. The comparison value can be made to a fixed level, L (low) or H (high), or it can be disregarded, designated X (don't care). In addition, comparison Can also be made to a computed value, such as the parity bit. Each 11 bits pairs represents one phase of the signature. NO through P10 represents the PC to keyboard ED command. N11 through P21 represents the keyboard to PC FA acknowledge. N22 through P32 represents the PC to keyboard sending the LED status. Finally, N33 through P43 represents the second acknowledge mentioned earlier.

Some compatibility issues: Note the phrase “some keyboards don't hold”. Some keyboards hold their data when transmitting to the PC so that the data is valid on both the leading HTLCT as well as the trailing LTHCT. However, some keyboards do not hold their data for the trailing LTHCT, and, thus, “don't cares” are used for the comparison logic #517. For keyboards that hold their data, these “don't cares” could be replaced with the preceding HTLCT data in order to maximize the signature comparison. On the other hand, using “don't cares” allows the comparison logic to function correctly with both type of keyboards. It is easy enough to allow for a switch to enable this feature, or even logic to automatically make this determination. Another possible compatibility issue is that the reserved bits detected on P25 through N30 are compared against low, as the PC BIOS and/or PC controller is supposed to write these bits with zero. If some PC violated this condition, then some or all of these bits might be made “don't cares”. This would also affect the detected parity for that phase.

During the third phase, N22 through P32, the PC is sending the LED status to the keyboard. As the LED status is not static (it can change), the parity associated with this status is also not static. One option is to ignore the parity bit during this phase. However, as shown in this embodiment, the parity bit for that phase is computed by exclusive ORing P22, P23, and P24, and is used by comparison logic #517.

Obviously many variations are possible, all being tradeoffs between complexity of design, compatibility with different PCs and keyboards, and cost, and these are presumed obvious.

So far, the description of the preferred embodiment has been shown to illustrate a way of detecting the keyboard LED's. Some practical considerations were omitted for clarity, which can now be addressed.

The clock on the practical keyboard has a very slow rise time, often well in excess of one or even ten microseconds, and varies considerably from system to system. This slow clock is a result of the open collector signal lines that are used by the keyboard and PC (open collector is used as a simple way to make them bidirectional and prevent damage). In practice, this slow clock could cause multiple clock glitches for fast logic. One of several solutions is to use a logic gate with hysteresis and limited response bandwidth. Another technique is to sample the clock line with a high frequency clock. For example, if the clock line was sampled every one to two microseconds, this would in general allow the sampled clock to be glitch free with respect to the slow rise time.

Another practical concern is the delay. Although perfectly feasible from a practical point of view, it lacks elegance and may add cost.

Finally, inverting the clock to produce the HTLCT shift register may be difficult with certain logic, or require an extra global clock line (although it is no problem with many logic parts).

One practical implementation of this preferred embodiment that uses a single clock, and no asynchronous delay is illustrated in FIG. 9. Many FPGAs (field programmable gate arrays) have an internal clock #684 of low accuracy and poor temperature stability, typically a factor of 3 to 1. These FPGAs can use the internal oscillator, suitably divided as a single master clock. For example, the Xilinx: XC5202 FPGA can generate a 1 MHz clock, with accuracy of +/−50%. This clock #684 is of sufficient accuracy that the PC/keyboard clock line #601 can be sampled by flip-flop #685 to generate sampled output #609. As mentioned before, by sampling the PC/keyboard clock #601 at this slow rate, typically one microsecond, this eliminates the need to use a special hysteresis or other deglitching circuit. Note that flip-flop #684 samples data #602 to generate sampled data #670. When sampling any signals asynchronously, metastability of flip-flops #684 and #685 is a concern. However, as the master clock output #608 period is very low with respect to the metastability settling time, metastability can be ignored. Flip-flop #680 generates a delayed version of the sampled clock on line #673. The sampled clock #609 and its delayed version #673 are used by AND gates #682 and #683 (note one input inverts) to generate SHFTP #671 which goes high for one clock when the sampled clock #609 makes a LTHCT, and similarly SHFTN #672 goes high for one clock when the sampled clock #609 makes a HTLCT. Shift registers #610 and #611 are similar to their FIG. 6 and FIG. 7 counterparts #410, #510, #511, and #511, respectively, but contain a clock enable input. If the clock enable input is low, the LTHCT is ignored. Also, if the clock enable input is high, the LTHCT samples (captures) the data input and shifts, and the shift register operates normally. Note that there is only a single master clock #608, and all logic uses only the LTHCT of master clock #608. Comparison logic #617 functions identically to FIG. 7 logic #517. Enable flip-flops #613, #614, and #615 are enabled from the output of AND-gate #618, signal #607. This signal is the ANDing of match signal #605 and compare signal #606. Thus, comparison is only performed when compare signal #606 goes high. Compare signal #606 goes high only for one master clock #608 period immediately following SHFTP #671. This allows one master clock #608 period delay for the comparison logic to decide if the signature is a match, and output match #605 appropriately, and thus eliminates the time delay #517 shown in FIG. 7. If a match occurred, then enable flip-flops #613, #614, and #615 sample the LED status, analogous to enable flip-flops #513, #514, and #515 of FIG. 7.

Further variations in the invention are possible. Thus, while the invention has been disclosed in limited embodiments, it is not so limited but is of a scope defined by the following claim language which may be broadened by an extension of the right to exclude others from making, using or selling the invention as is appropriate under the doctrine of equivalents.

I claim:

1. A system for indicating the condition of a keyboard lock key for a computer, said system comprising:
a. a computer having a display screen,
b. a keyboard having at least one lock key and a corresponding lock key indicator, said indicator located on the keyboard,
c. a keyboard cable connecting the keyboard to the computer and intercepted by a junction,
d. a remote visual indicator, having one end connected to the junction and one end having an LED indicator for positioning in a location remote from the keyboard
e. a hardware signature analyzer in the junction for detecting the condition of the lock key, and
f. a power supply in the junction for powering the remote visual indicator.

2. A condition-indicator accessory for use with a computer having a display screen and a keyboard having at least one lock key and a visual indicator for said lock key, the accessory remotely indicating the condition of the lock key on the keyboard, said accessory comprising:
a. a keyboard cable connecting the keyboard to the computer and intercepted by a junction,
b. a remote visual indicator, having one end connected to the junction and one end having an LED indicator for positioning in a location remote from the keyboard,
c. activating means in the junction for detecting the condition of the lock key, and
d. a power supply in the junction for powering the remote visual indicator to indicate the condition of the lock key.

3. An accessory as claimed in claim 2 wherein the LED indicator end of the remote visual indicator is secured adjacent the display screen.

4. An accessory as claimed in claim 2 wherein the LED indicator end is removably attached to the display screen by means of a fabric-type fastener, cooperant parts of which are secured to the LED indicator end and the display screen respectively.

5. An accessory as claimed in claim 2 wherein the accessory includes a plurality of remote visual indicators, each connected to the junction for indicating the condition of respective lock keys, and the activating means includes means for detecting the condition of the respective lock keys.

6. An accessory as claimed in claim 5 wherein the LED indicator ends of the plurality of remote visual indicators are each secured adjacent the display screen.

7. An accessory as claimed in claim 5 wherein the LED indicator ends of the plurality of remote visual indicators are each removably attached to the display screen by means of a fabric-type fastener, cooperant parts of which are secured to the LED indicator ends and the display screen respectively.

8. An accessory as claimed in claim 2 wherein the activating means detects the condition of the lock key by a hardware signature analyzer.

9. A system for remotely indicating the condition of a keyboard lock key for a computer, said system comprising:
a. a computer having a display screen,
b. a keyboard having at least one lock key and a corresponding lock key indicator, said indicator located on the keyboard,
c. a keyboard cable connecting the keyboard to the computer and intercepted by a junction,
d. a remote visual indicator, having one end connected to the junction and one end having an LED indicator for positioning in a location remote from the keyboard,
e. activating means in the junction for detecting the condition of the lock key, and
f. a power supply in the junction for powering the remote visual indicator to indicate the condition of the lock key.

10. A system as claimed in claim 9 wherein the LED indicator end of the remote visual indicator is secured adjacent the display screen.

11. A system as claimed in claim 9 wherein the LED indicator end is removably attached to the display screen by means of a fabric-type fastener, cooperant parts of which are secured to the LED indicator end and the display screen respectively.

12. An accessory as claimed in claim 9 wherein the accessory includes a plurality of remote visual indicators, each connected to the junction for indicating the condition of respective lock keys, and the activating means includes means for detecting the condition of the respective lock keys.

13. An accessory as claimed in claim 12 wherein the LED indicator ends of the plurality of remote visual indicators are each secured adjacent the display screen.

14. An accessory as claimed in claim 12 wherein the LED indicator ends of the plurality of remote visual indicators are each removably attached to the display screen by means of a fabric-type fastener, cooperant parts of which are secured to the LED indicator ends and the display screen respectively.

15. A system as claimed in claim 9 wherein the activating means detects the condition of the lock key by a hardware signature analyzer.
